(19) United States
(12) Patent Application Publication
(10) Pub. No.: US 2021/0060999 A1
(43) Pub. Date: Mar. 4, 2021

(54) PAINT BOX

(71) Applicant: LION PENCIL CO., LTD., NEW TAIPEI CITY (TW)

(72) Inventor: HUNG JEN CHANG, NEW TAIPEI CITY (TW)

(21) Appl. No.: 16/726,974

(22) Filed: Dec. 26, 2019

(30) Foreign Application Priority Data
Sep. 3, 2019 (TW) 108211703

(51) Int. Cl. B44D 3/04

(52) U.S. Cl. CPC B44D 3/04

(57) ABSTRACT

A paint box includes a box body including a bottom portion and a surrounding wall, a cover body and a pigment tray. The bottom portion and the surrounding wall define an accommodation space for accommodating pigment. The cover body is detachably disposed on the box body and has covered, opened state and separated states with respect to the box body. The pigment tray is detachably disposed in the box body and has stored and detached states with respect to the box body for carrying pigment. In the stored and closed states, the pigment tray is between the cover body and the box body. In the stored state, the cover body is opened or separated from the box body to expose the pigment of the pigment tray. In the detached state, the cover body is opened or separated from the box body to expose the pigment in the box body.

### FIELD OF THE INVENTION

The present invention relates to a storage box, and more particularly to a paint box for a pigment and a painting tool.

### BACKGROUND OF THE INVENTION

In addition to drawing paper, watercolor paintings require pigments, pens and appropriate color adjustment space to complete the painting. The fixed painting place is convenient for the user to place the pigments and the painting tools. However, in most cases, the user has the need to carry the painting tools for painting in different places. In addition, the design of the storage of the pigments or the painting tools is rare and lakes of convenience. Therefore, the present invention provides a paint box to satisfy the user's painting performance and painting experience.

### SUMMARY OF THE INVENTION

The present invention provides a paint box, which uses a limited space to store multi-color pigments, as such, the paint box is easy to carry and paint.

The present invention provides a paint box, which can be used as a drawing tool and can accommodate painting tools and is multifunctional and portable.

In order to achieve one or a portion of or all of the objects or other objects, an embodiment of the invention provides a paint box, which includes a box body, a cover body and a pigment tray. The box body includes a bottom portion and a surrounding wall. The bottom portion and the surrounding wall define an accommodation space for accommodating at least one pigment. The cover body is detachably disposed on the box body and has a covered state, an opened state and a separated state with respect to the box body. The pigment tray is detachably disposed in the box body. The pigment tray has a stored state and a detached state with respect to the box body and is for carrying at least one pigment. When the pigment tray is in the stored state and the cover body is in the closed state, the pigment tray is disposed between the cover body and the box body. When the pigment tray is in the stored state, the cover body is opened or separated relative to the box body to expose the at least one pigment of the pigment tray. When the pigment tray is in the detached state, the cover body is opened or separated relative to the box body to expose the at least one pigment in the box body.

In the paint box of the present invention, the pigment tray is detachably disposed on the box body and has a stored state and a detached state with respect to the box body. Thus, the paint box has a reduced volume and the pigment tray can store multicolor pigment in a limited space together with the box body. Further, since the cover body is detachably disposed on the box body and has a separated state with respect to the box body, the cover body can be used alone as a drawing tool, so that the paint box of the present invention has functions other than pigment storage.

### BRIEF DESCRIPTION OF THE DRAWING

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic perspective view of a paint box according to an embodiment of the present invention;

FIG. 2 is another schematic perspective view of the embodiment shown in FIG. 1;

FIG. 3 is still another schematic perspective view of the embodiment shown in FIG. 1; and

FIG. 4 is yet another schematic perspective view of the embodiment shown in FIG. 1.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

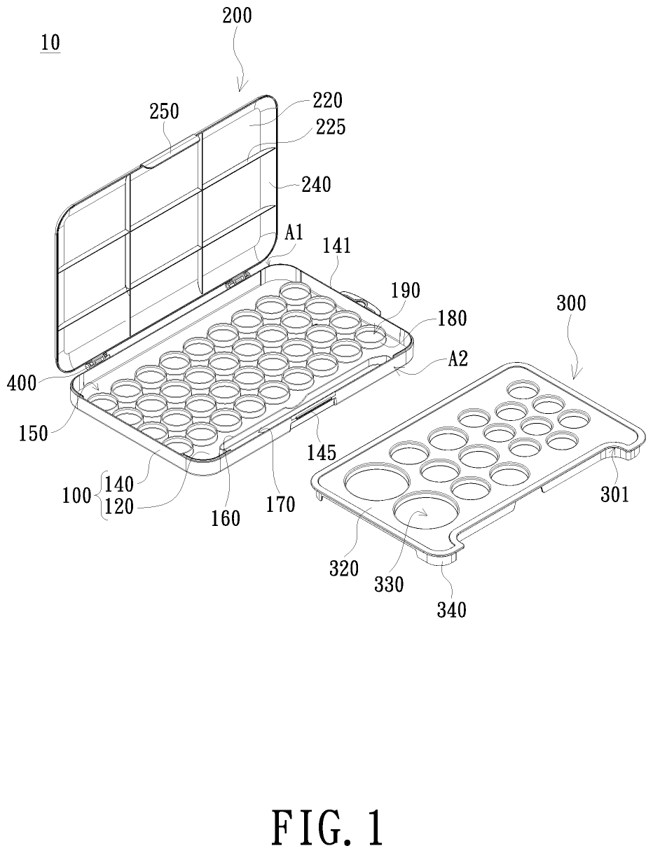

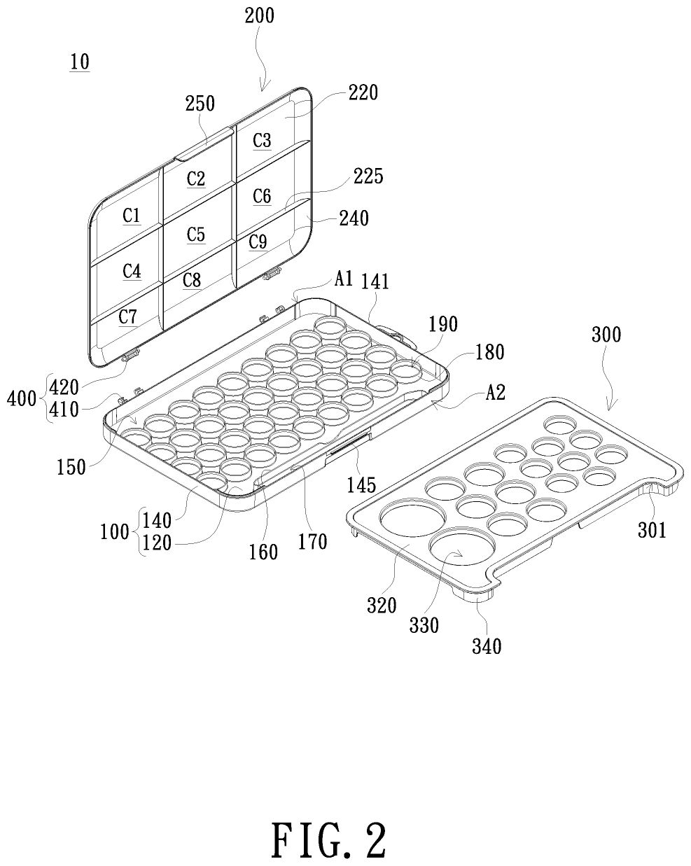

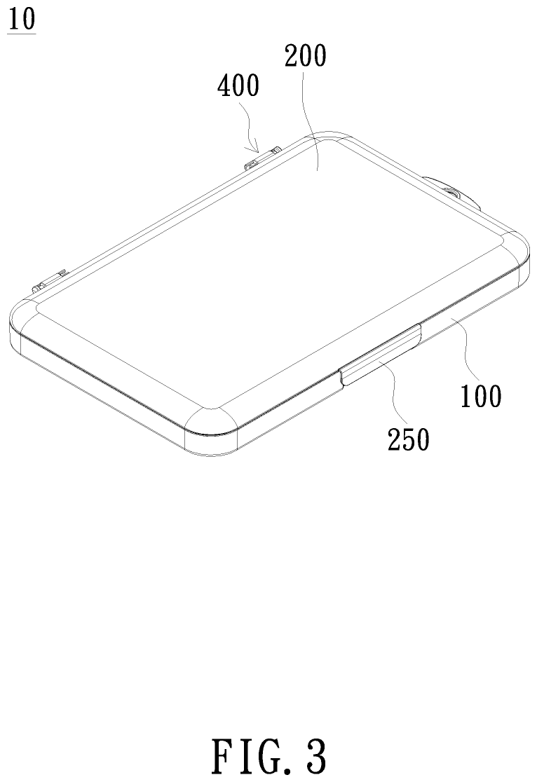

FIGS. 1 to 3 are schematic perspective views of a paint box according to an embodiment of the present invention. As shown in FIG. 1, the paint box 10 includes a box body 100, a cover body 200 and a pigment tray 300. The box body 100 includes a bottom portion 120 and a surrounding wall 140. The bottom portion 120 and the surrounding wall 140 define an accommodation space 150 for accommodating at least one pigment. The cover body 200 is detachably disposed on the box body 100 and has a covered state, an opened state and a separated state with respect to the box body 100. FIGS. 1 to 3 are schematic views of the cover body 200 in the opened state, the separated state and the covered state respectively. The pigment tray 300 is detachably disposed in the box body 100 and has a stored state and a detached state with respect to the box body 100. The pigment tray 300 is for carrying at least one pigment. The pigment trays 300 shown in FIGS. 1 and 2 are all in a detached state. The cover body 200 is opened or separated from the box body 100 to expose at least one pigment in the box body 100 when the pigment tray 300 is in the detached state. Since both of the box body 100 and the pigment tray 300 can be used for accommodating/carrying pigments, the paint box 10 of the embodiment can accommodate multi-color pigments, thereby improving the convenience of painting, completing all colors, and improving the performance of painting.

The structure of the box body 100, the cover body 200 and the pigment tray 300 will be further described below. As shown in FIGS. 1 to 3, the embodiment further includes a pivoting device 400 for allowing the cover body 200 to be pivotally disposed on one side (e.g., first side A1) of the box body 100, so the cover body 200 can pivot between the covered state and the opened state, but not limited thereto. For example, the cover body 200 may be slidably disposed on the box body 100 and is slidable between the covered state and the opened state with respect to the box body 100.

The pivoting device 400 may include a first pivoting member 410 and a second pivoting member 420. The first pivoting member 410 is disposed on the first side A1 of the box body 100. The second pivoting member 420 is corresponding to the first pivoting member 410 and disposed on the cover body 200 and detachably coupled to the first pivoting member 410. As shown in FIG. 2, the first pivoting member 410 may include, for example, a shaft hole, the second pivoting member 420 may be, for example, a pivot shaft, and the pivot shaft is disposed in the shaft hole and is rotatable in the shaft hole. Specifically, the first pivoting member 410 further has a notch communicating with the shaft hole, so the second pivoting member 420 is pivotally disposed in the shaft hole via the notch. In response to the pivoting of the cover body 200 and its angle with respect to the box body 100, the first pivoting member 410 can interfere with the second pivoting member 420 to prevent the second pivoting member 420 from detaching from the shaft hole, thereby maintaining the pivotal connection of the cover body 200 to the box body 100 and the pivot between the covered state and the opened state. In contract, the cover body 200 can be pivoted with respect to the box body 100 to a specific angle, such as 90 degrees, to detach the second pivoting member 420 from the shaft hole, so the cover body 200 is in the separated state.

The box body 100 may further include a first surrounding wall 160 disposed in the accommodation space 150. The first surrounding wall 160 is located on the second side A2 opposite to the first side A1 and may extend upward from the inner surface of the bottom portion 120 to define the first accommodation groove 170 in the accommodation space 150 and adjacent to the second side A2, but the invention is not limited thereto. The first surrounding wall 160 can also be connected to the surrounding wall 140 at its both ends to define the first accommodation groove 170. The first accommodation groove 170 may be exposed when the cover body 200 pivots to the opened state. Preferably, the first accommodation groove 170 is an elongated space and is adapted to accommodate drawing tools or pens. The pen includes, but is not limited to, a drawing pen such as a pencil, a watercolor pen and a water pen. The height of the first surrounding wall 160 is preferably no greater than the height of the surrounding wall 140.

The box body 100 may further include a plurality of second surrounding walls 180 disposed in the accommodation space 150. The second surrounding walls 180 may extend upward from the inner surface of the bottom portion 120 to define a plurality of second accommodation grooves 190 in the accommodation space 150 for accommodating a plurality of pigments. The pigment may be, for example, a bulk pigment or a paste pigment, but is not limited thereto. The pigment may be provided with the paint box 10 or may be filled by a user. For example, the box body 100 may further include a plurality of pigments respectively filled in the second accommodation grooves 190, and the pigments are, for example, in the form of a powder watercolor. The second accommodation grooves 190 may have different sizes to match the color pigments of different amounts. The height of the second surrounding wall 180 is preferably no greater than the height of the surrounding wall 140. For example, the height of the surrounding wall 140 is greater than or equal to twice the height of the second surrounding wall 180 or the first surrounding wall 160.

The cover body 200 includes a top wall 220 and preferably further includes a surrounding wall 240. The top wall 220 and the surrounding wall 240 define a space. The surrounding wall 240 may be inclined relative to the top wall 220 to make the cover body 200 slightly disk-shaped. The cover body 200 of the present embodiment can also function as a palette when the cover body 200 is in the opened state or the separated state. As shown in FIGS. 1 and 2, the inner surface of the top wall 220 has at least one convex rib 225. The at least one convex rib 225 is staggered to divide the inner surface of the top wall 220 into a plurality of regions C1 to C9 for the different color matching needs. In the present embodiment, the cover body 200 further has a latching member 250, and the box body 100 preferably has a latching portion 145 corresponding to the latching member 250. The cover body 200 and the box body 100 can be further secured to each other by the latching member 250 and the latching portion 145 when the cover body 200 and the box body 100 are in the covered state.

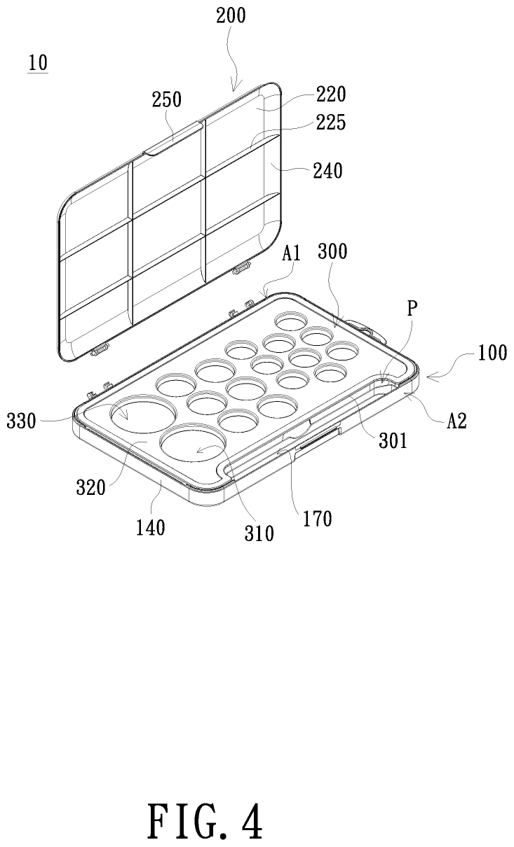

FIG. 4 is another perspective view of the embodiment shown in FIGS. 1 to 3, wherein the pigment tray 300 shown in FIG. 4 is in a stored state. As shown in FIG. 4, the periphery of the pigment tray 300 may correspond to the shape enclosed by the surrounding wall 140, but is not limited thereto. In other embodiments, the pigment tray 300 may also be stacked on the top surface 141 (shown in FIG. 1) of the surrounding wall 140. It is understood that the deposition of the pigment tray 300 on the surrounding wall 140 is not premised on that the shape of the periphery of the pigment tray 300 corresponds to the shape of the box body 100.

As shown in FIGS. 1, 2 and 4, the pigment tray 300 also has an inwardly-concave edge 310. When the pigment tray 300 is in the stored state, the side of the pigment tray 300 having the inwardly-concave edge 301 preferably corresponds to the second side A2 of the box body 100. The inwardly-concave edge 301 can serve as a gripping portion through which the user can grip the pigment tray 300, and can also form an opening P with the surrounding wall 140 on the second side A2 to expose at least a portion of the accommodation space 150. In the present embodiment, the shape of the inwardly-concave edge 301 and the opening P corresponds to the shape of the first accommodation groove 170. For example, the inwardly-concave edge 301 is an elongate shallow recess, so that the opening P is formed in an elongated shape corresponding to the shape of the first accommodation groove 170, but is not limited thereto. Preferably, the range of the opening P includes the first accommodation groove 170. When the pigment tray 300 is disposed in the box body 100, the opening P exposes at least the first accommodation groove 170 in the accommodation space 150, and the user can place or take the pens.

It is understood that the realization of the gripping portion and the exposure of the first accommodation groove 170 are not limited by the inwardly-concave edge 301 of the pigment tray 300. In other embodiments, the pigment tray 300 may also form a through hole (not shown) in its main body 320 to correspond to the first accommodation groove 170. The function of the through hole is equivalent to the opening P. In an embodiment in which the main body 320 of the pigment tray 300 has a through hole, the shape of the periphery of the pigment tray 300 corresponds to the shape enclosed by the surrounding wall 140.

The pigment tray 300 of the present embodiment further has at least one support member 340. The at least one support member 340 may be disposed on the lower side of the pigment tray 300 and is preferably for allowing the pigment tray 300 to be disposed in the accommodation space 150. In an embodiment, the support member 340 is disposed on the lower side of the pigment tray 300 substantially along the periphery of the main body 320.

When the pigment tray 300 is in the stored state, the at least one support member 340 extends to the bottom portion 120 in the accommodation space 150, so the pigment tray 300 can stand at the bottom portion 120. The main body 320 and the support member 340 of the pigment tray 300 can be completely received in the accommodation space 150, but not limited thereto. The main body 320 may also be exposed to the accommodation space 150 and can be further stacked on the top surface 141 of the surrounding wall 140. In an embodiment, the support member 340 can contact the surrounding wall 140, so the pigment tray 300 is secured to the top surface 141 relative to the box body 100.

The pigment tray 300 further includes a plurality of grooves 330 for accommodating a plurality of pigments. The grooves 330 may be recessed from the main body 320 of the pigment tray 300, but not limited thereto. The pigment may be, for example, a bulk pigment or a paste pigment, but is not limited thereto. The pigment may be provided with the paint box or may be filled by a user. For example, the pigment tray 300 may further include a plurality of pigments respectively filled in the grooves 330, and the pigments are, for example, in the form of a powder watercolor. The depth of the groove 330 may be the same as that of the second surrounding wall 180 or the first surrounding wall 160, but not limited thereto. When the pigment tray 300 is in the stored state, the wall of the groove 330 protrudes downward into the accommodation space 150 of the box body 100. In other embodiments, the pigment tray 300 extends upwardly from the main body 320 to form an accommodation groove (not shown) for accommodating the pigment.

As shown in FIG. 4, when the pigment tray 300 is in the stored state, the cover body 200 is opened or separated from the box body 100 to expose at least one pigment on the pigment tray 300. Thus, according to the painting requirements, the user can take the pigment on the pigment tray 300 when the pigment tray 300 is in a stored state or take the pigment on the pigment tray 300 or in the box body 100 when the pigment tray 300 is in a detached state. In addition, the user can take the pen from the first accommodation groove 170 regardless of the pigment tray 300 is in a stored state or a detached state. Since the pigment tray 300 can be received in the box body 100, the paint box 10 of the present invention has a reduced size and is easy to carry. Further, since the cover body 200 can be separated from the box body 100, the user can conveniently operate the cover body 200 in accordance with the drawing habits.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A paint box, comprising:
a box body, comprising a bottom portion and a surrounding wall, wherein the bottom portion and the surrounding wall define an accommodation space for accommodating at least one pigment;
a cover body, detachably disposed on the box body and having a covered state, an opened state and a separated state with respect to the box body; and
a pigment tray, detachably disposed in the box body, wherein the pigment tray has a stored state and a detached state with respect to the box body and is for carrying at least one pigment;
wherein when the pigment tray is in the stored state and the cover body is in the closed state, the pigment tray is disposed between the cover body and the box body; when the pigment tray is in the stored state, the cover body is opened or separated relative to the box body to expose the at least one pigment of the pigment tray; when the pigment tray is in the detached state, the cover body is opened or separated relative to the box body to expose the at least one pigment in the box body.

2. The paint box according to claim 1, wherein the cover body is further pivotally disposed on a first side of the box body and pivots between the covered state and the opened state.

3. The paint box according to claim 2, wherein the box body further has a first pivoting member disposed on the first side, the cover body has a second pivoting member corresponding to the first pivoting member, the second pivoting member is detachably coupled to the first pivoting member, and the cover body is in the separated state when the second pivoting member is detached from the first pivoting member.

4. The paint box according to claim 2, wherein the accommodation space is further provided with a first surrounding wall, the first surrounding wall defines a first accommodation groove on a second side of the box body, and the second side is opposite to the first side.

5. The paint box according to claim 4, wherein the accommodation space is further provided with a plurality of second surrounding walls, the second surrounding walls define a plurality of second accommodation grooves in the accommodation space for accommodating a plurality of pigments.

6. The paint box according to claim 1, wherein the cover body further has at least one convex rib disposed on an inner surface of the cover body, and the at least one convex rib divides the inner surface into a plurality of regions.

7. The paint box according to claim 1, wherein the pigment tray has an inwardly-concave edge corresponding to a second side of the box body, and the inwardly-concave edge forms an opening with the surrounding wall to expose at least a portion of the accommodation space when the pigment tray is disposed in the box body.

8. The paint box according to claim 1, wherein the pigment tray further comprises a plurality of grooves for accommodating a plurality of pigments, and the grooves are located in the accommodation space of the box body when the pigment tray is disposed in the box body.

9. The paint box according to claim 1, wherein the pigment tray further has at least one support member for allowing the pigment tray to be disposed in the box body.

10. The paint box according to claim 9, wherein the pigment tray is disposed on the bottom portion of the box body through the support member when the pigment tray is in the stored state.
